(19) United States
(12) Patent Application Publication
(10) Pub. No.: US 2024/0268586 A1
(43) Pub. Date: Aug. 15, 2024

(54) KNIFE RACK

(71) Applicant: DOTS TECHNOLOGY INC., New Taipei City (TW)

(72) Inventors: Race Wu, New Taipei City (TW); Po-Chun Chuang, Taichung (TW); Po-Yu Chen, Taichung (TW)

(73) Assignee: DOTS TECHNOLOGY INC., New Taipei City (TW)

(21) Appl. No.: 18/509,931

(22) Filed: Nov. 15, 2023

(30) Foreign Application Priority Data
Feb. 10, 2023 (TW) 112201170

(51) Int. Cl. A47G 21/14

(52) U.S. Cl. CPC A47G 21/14

(57) ABSTRACT

A knife rack includes a box body having a bottom, a plurality of peripheral walls surrounding the bottom, an accommodating space surrounded by the peripheral walls and the bottom and an opening provided where the accommodating space communicates with the outside, a top cover covering the opening and provided with a plurality of long slotted holes, and a plurality of round balls set within the accommodating space of the box body and used as a support structure for supporting knifes. The point-like contact between the round balls and the blades of stored knives can greatly reduce the contact area between the round balls and the blades, and the gaps between the round balls are conducive to air circulation.

### BACKGROUND OF THE INVENTION

### 1. Field of the Invention

The present invention relates to knife racks, in particular to a knife rack with good breathability and easy cleaning.

### 2. Description of the Related Art

A general knife rack is equipped with a plurality of slots of different sizes on a box for inserting and placing knives of various sizes. Although this type of knife rack can provide basic needs for placing knives, the inside of these slots is not easy to clean. After long-term use, it is easy for dirt or mold to accumulate, but since it is not easy to detect inside the slots, it is difficult for users to find it.

In order to improve this shortcoming, someone later proposed the method of arranging columnar objects in a box as a knife rack, for example, as disclosed in Japanese Patent Application Laid-Open No. 10-234497. The method of this case is to set an opening above a box so that the box has a space connected to the outside, and then put a plurality of columns in the space, and use these columns to serve as a support for knifes. The advantage of this approach is that the columns can be easily removed and cleaned, however, the disadvantage is that these columns will be in contact with the blades of the knives. especially when the blades of the knives contain moisture, these columns will stick to the blades due to moisture. As a result, the knives will be difficult to dry, and the blades will also be prone to leaving water marks after drying.

### SUMMARY OF THE INVENTION

The main object of the present invention is to provide a knife rack with good breathability and easy cleaning.

To achieve the above object, the knife rack of the present invention comprises a box body having a bottom, a plurality of peripheral walls surrounding the bottom, an accommodating space surrounded by the peripheral walls and the bottom and an opening provided where the accommodating space communicates with the outside, a top cover covering the opening and provided with a plurality of long slotted holes, and a plurality of round balls set within the accommodating space of the box body.

The knife rack of the above structure of the present invention allows the knives to be inserted through the long slotted holes, and uses the round balls as a supporting structure to support the blades of the inserted knives. The gaps between round balls can be used as channels for air circulation and water evaporation.

Preferably, the bottom of the box body is provided with a plurality of through holes.

Preferably, the peripheral walls of the box body are provided with a plurality of ventilation holes.

### BRIEF DESCRIPTION OF THE DRAWINGS

FIG. 1 is a schematic perspective view of the present invention.

FIG. 2 is an exploded view of the present invention.

FIG. 3 is schematic cross-sectional view of the present invention.

FIG. 4 is a schematic bottom view of the second embodiment of this invention.

FIG. 5 is a schematic side view of the third embodiment of the present invention.

### DETAILED DESCRIPTION OF THE INVENTION

The applicant first explains here that throughout the specification, including the embodiment described below and the claims in the scope of the patent application, the nouns related to directionality are based on the directions in the drawings. Secondly, in the preferred embodiment and drawings that will be introduced below, the same element numbers represent the same or similar elements or their structural features. The directions indicated in the instructions are based on the directions of the drawings for ease of explanation and are not limited thereto.

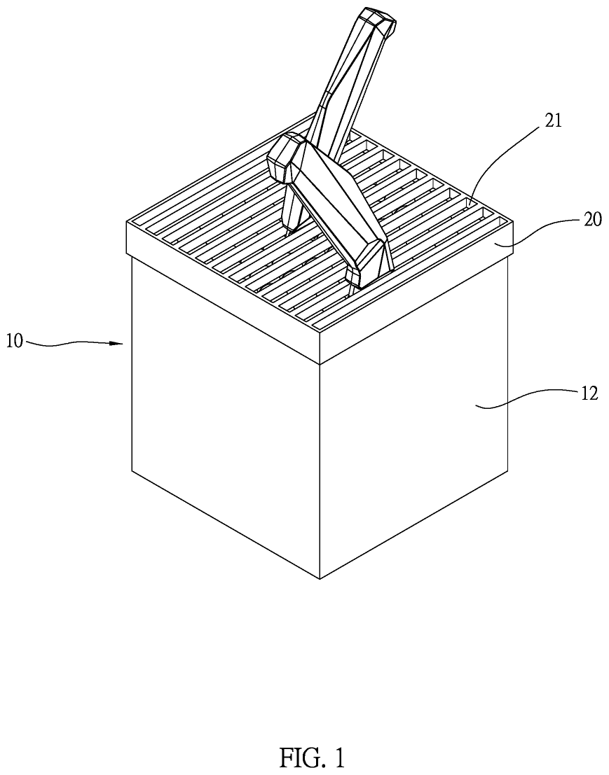

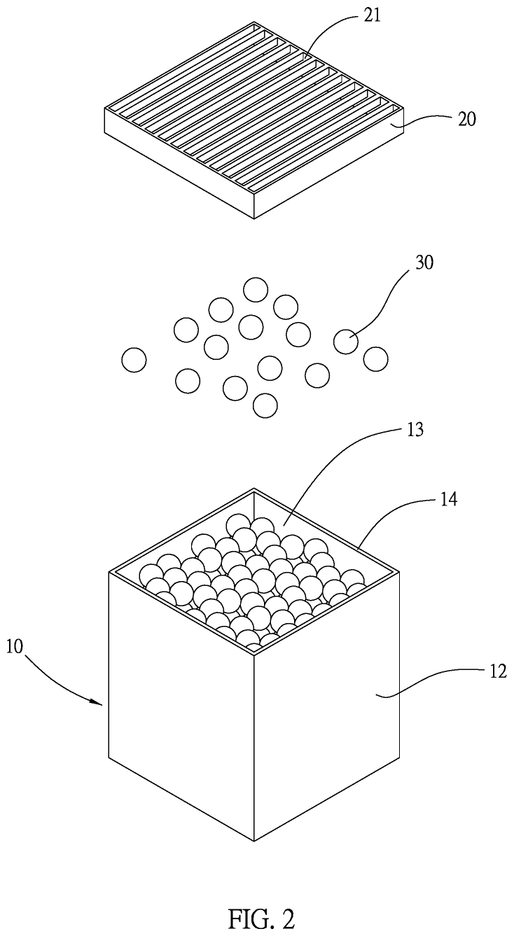

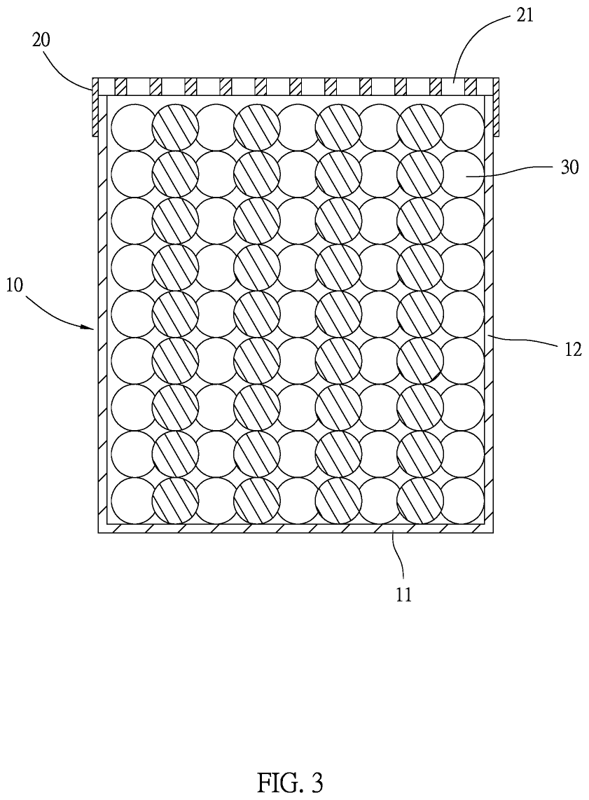

Referring to FIGS. 1-3, the knife rack of the first embodiment of the present invention comprises: a box body 10, a top cover 20, and a plurality of round balls 30.

The shape of the box body 10 is not limited, it can be square, round or triangular, etc. In this embodiment, a rectangular box body is used as an illustration. The box body 10 comprises a bottom 11, a plurality of peripheral walls 12 surrounding the bottom 11, an accommodating space 13 surrounded by the peripheral walls 12 and the bottom 11, and an opening 14 is provided where the accommodating space 13 communicates with the outside.

The top cover 20 is provided on the opening 14, and the top cover 20 is provided with a plurality of long slotted holes 21, and the long slotted holes can allow the blades of knives to pass through respectively.

The round balls 30, of any material, are set within the accommodating space 13 of the box body. The volume occupied by the round balls 30 is preferably more than one-third of the volume of the accommodating space, because if there are too few round balls, the support effect will be poor. Moreover, the diameter of the round balls is preferably between 10 and 20 mm, because if the round balls 30 are too small, the gaps between them will be too small and dense, which is not conducive to the circulation of air. However, if the round balls 30 are too large, there will be too few round balls in contact with the blades, and the support effect on the blades will be poor, and the knives will not be easy to insert. The round balls 30 can be all of the same size or a mixed configuration of two or more round balls of different sizes. The width of the long slotted holes needs to be smaller than the minimum diameter of the round balls.

With the structure of the first embodiment of the present invention described above, knives can be inserted into the accommodating space 13 through the long slotted holes 21 of the top cover 20 when being stored, as shown in FIG. 1. Because the contact between the round balls 30 and the blade is not a surface contact or a linear contact but a point-like contact, the contact area between the round balls 30 and the blade can be greatly reduced. In addition, there are lots of gaps between round balls, so it is conducive to air circulation and water evaporation, which can effectively improve the shortcomings of previous products.

The structure of this invention is also very convenient for cleaning. You only need to remove the top cover 20 and then the round balls 30 can be taken out for cleaning. After washing and drying, put the round balls 30 back into the accommodating space 13 and cover it back up with the top cover 20.

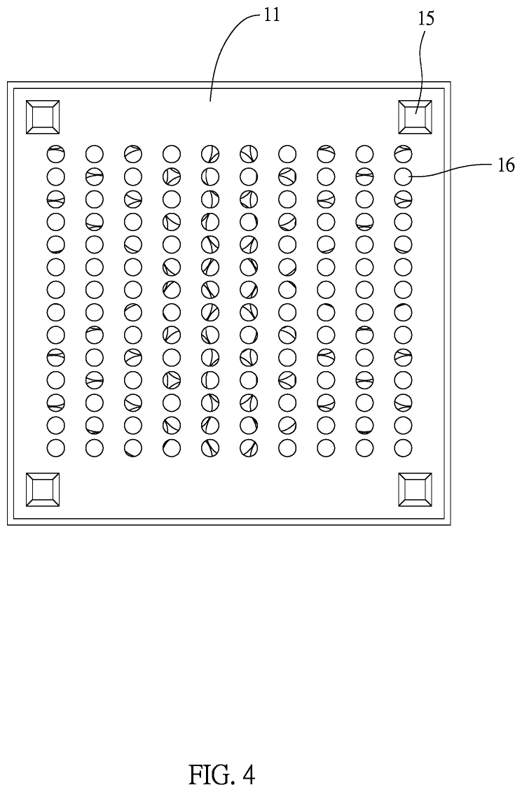

In order to make the ventilation effect better, this invention can also set foot members 15 on the bottom 11 of the box body to raise the bottom 11, and a plurality of through holes 16 are provided on the bottom 11, as shown in the second embodiment of the present invention in FIG. 4, so that the through holes 16 can form air flow channels with the opening 14 above, which is more conducive to air circulation, and if there is water in the round balls 30 or the blade, the water can be drained out of the accommodating space 13 through the through holes 16 downwards. The shape of the through holes 16 is not limited, but the diameter of the through holes 16 needs to be smaller than the minimum diameter of the round balls 30 to prevent the round balls from protruding from the through holes.

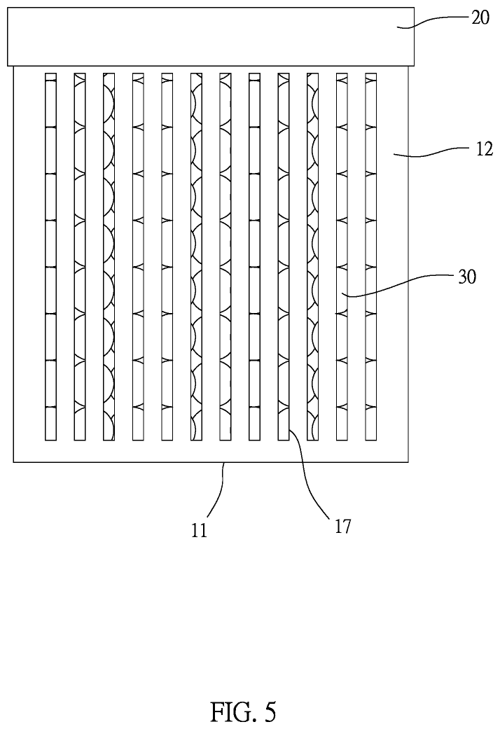

As shown in FIG. 5, the third embodiment of the present invention is shown. In addition to being provided with a plurality of through holes 16 on the bottom 11 of the box body 10 of the present invention, a plurality of ventilation holes 17 can be provided on the peripheral walls 12 of the box body. This can further increase the breathability of the accommodating space 13. The user can also directly see the internal conditions of the accommodating space 13 through the ventilation holes 17. If the round balls 30 are dirty, they can be easily detected.

In this embodiment, although the ventilation holes 17 are expressed in strip shapes, they are not limited to this. The width or size of the ventilation holes 17 must be smaller than the minimum diameter of the round balls 30 to prevent the round balls from protruding from the ventilation holes.

What is claimed is:

1. A knife rack, comprising:
a box body comprising a bottom, a plurality of peripheral walls surrounding said bottom, an accommodating space surrounded by said peripheral walls and said bottom, and an opening provided where said accommodating space communicates with the outside;
a top cover provided on said opening, said top cover being provided with a plurality of long slotted holes; and
a plurality of round balls set within said accommodating space of said box body, the volume occupied by said round balls being more than one-third of the volume of said accommodating space.

2. The knife rack as claimed in claim 1, wherein said bottom of said box body is provided with a plurality of through holes.

3. The knife rack as claimed in claim 2, wherein the diameter of said through holes is smaller than the minimum diameter of said round balls.

4. The knife rack as claimed in claim 3, wherein said bottom of said box body is provided with a plurality of foot members.

5. The knife rack as claimed in claim 1, wherein said peripheral walls of said box body are provided with a plurality of ventilation holes.

6. The knife rack as claimed in claim 5, wherein the width of said ventilation holes is less than the minimum diameter of said round balls.

7. The knife rack as claimed in claim 2, wherein said peripheral walls of said box body are provided with a plurality of ventilation holes.

8. The knife rack as claimed in claim 5, wherein the width of said ventilation holes is less than the minimum diameter of said round balls.

9. The knife rack as claimed in claim 1, wherein the diameter of said round balls is preferably between 10˜20 mm.

10. The knife rack as claimed in claim 2, wherein the diameter of said round balls is preferably between 10˜20 mm.

11. The knife rack as claimed in claim 5, wherein the diameter of said round balls is preferably between 10˜20 mm.
